(19) United States
(12) Patent Application Publication
(10) Pub. No.: US 2026/0237950 A1
(43) Pub. Date: Aug. 13, 2026

(54) SOCKET

(71) Applicant: OMRON Corporation, Kyoto-shi, Kyoto (JP)

(72) Inventors: Tomokazu IKEDA, Kyoto-shi, Kyoto (JP); Kiyokazu MATSUNAGA, Kyoto-shi, Kyoto (JP); Yoshikazu TAJIRI, Kyoto-shi, Kyoto (JP)

(21) Appl. No.: 19/160,608

(22) PCT Filed: Feb. 21, 2024
(86) PCT No.: PCT/JP2024/006232

§ 371 Date: Aug. 28, 2025

(30) Foreign Application Priority Data
Mar. 2, 2023 (JP) 2023-031823

(51) Int. Cl. H01R 33/76; H01R 9/24; H01R 9/26; H01R 13/66

(52) U.S. Cl. CPC H01R 33/76; H01R 9/2466; H01R 9/2491; H01R 9/2608; H01R 13/6658

(57) ABSTRACT

A socket according to the present invention comprises a housing and a substrate. The housing has a first attachment part and a second attachment part positioned spaced apart in the first direction. The first attachment part is configured so as to be attachable while an electronic device is electrically connected. The second attachment part is configured so as to be attachable to a support body. Among both end sections in the first direction Z, the substrate is positioned at an end section near the second attachment part inside the housing, and a circuit that can reduce the power consumption of the electronic device is mounted thereto. The housing includes an insulating part that is positioned between the second attachment part and the substrate and that insulates the substrate from the second attachment part.

### TECHNICAL FIELD

The present disclosure relates to a socket.

### BACKGROUND ART

Patent Document 1 discloses a relay socket to which a relay is connected.

### PRIOR ART DOCUMENT

### Patent Document

Patent Document 1: JP 2007-323897 A

### SUMMARY OF THE INVENTION

### Problems to be Solved by the Invention

In line with promotion of the SDGs, there has recently been increasing demand to reduce power consumption of electronic devices in order to achieve carbon neutrality.

An object of the present disclosure is to provide a socket capable of reducing power consumption of an electronic device to be connected.

### Solutions to the Problems

A socket according to one aspect of the present disclosure includes:
a housing including a first attachment part and a second attachment part that are positioned to be spaced apart in a first direction, the first attachment part being configured such that an electronic device is attachable in a state in which the electronic device is electrically connected, and the second attachment part being configured to be attachable to a support; and
a substrate on which a circuit configured to reduce power consumption of the electronic device is mounted, the substrate being positioned at an end part close to the second attachment part, of both end parts in the first direction inside the housing, wherein
the housing includes an insulating part that is positioned between the second attachment part and the substrate, and insulates the substrate from the second attachment part.

### Effects of the Invention

According to the present disclosure, it is possible to achieve a socket capable of reducing power consumption of an electronic device to be connected.

### BRIEF DESCRIPTION OF THE DRAWINGS

FIG. 1 is a perspective view showing a socket of one embodiment of the present disclosure.

FIG. 2 is a partial sectional view taken along line II-II of FIG. 1.

FIG. 3 is a partial sectional view taken along line III-III of FIG. 1.

FIG. 4 is a partial bottom view of the socket of FIG. 1.

FIG. 5 is a partial side view of the socket of FIG. 1, in a state in which a part of a housing is removed.

### DETAILED DESCRIPTION

Hereinafter, one example of the present disclosure will be described according to the accompanying drawings. The following description is merely exemplary in nature and is not intended to limit the present disclosure, the application of the present disclosure, and uses of the present disclosure. The accompanying drawings are schematic, and ratios of dimensions and the like do not necessarily match actual ones.

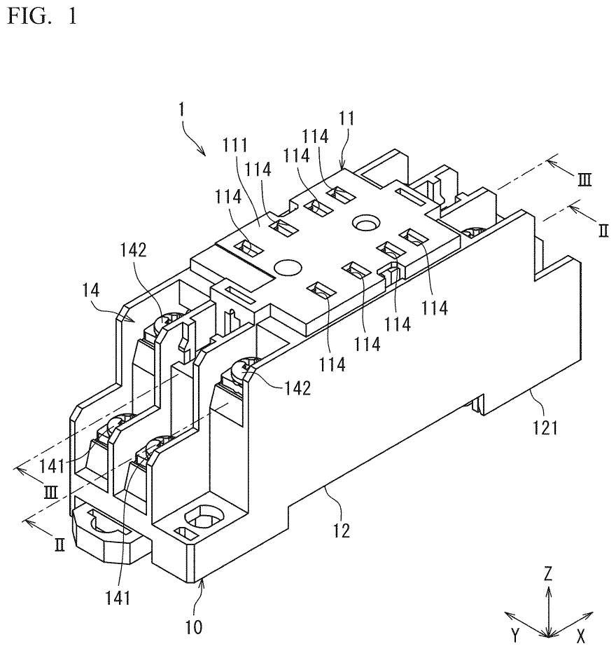

As shown in FIG. 1 to FIG. 3, a socket 1 according to one embodiment of the present disclosure includes a housing 10 and a substrate 20 that is positioned inside the housing 10. In the present embodiment, the housing 10 further includes a solid wire 30.

The housing 10 has a substantially rectangular parallelepiped shape as an example, and includes a first attachment part 11 and a second attachment part 12 that are positioned to be spaced apart in a first direction (for example, Z direction), and an insulating part 13. In the present embodiment, the housing 10 further includes a terminal connection part 14. The first attachment part 11 and the terminal connection part 14 are provided at one end of the housing 10 in the first direction Z, and the second attachment part 12 is provided at the other end of the housing 10 in the first direction Z.

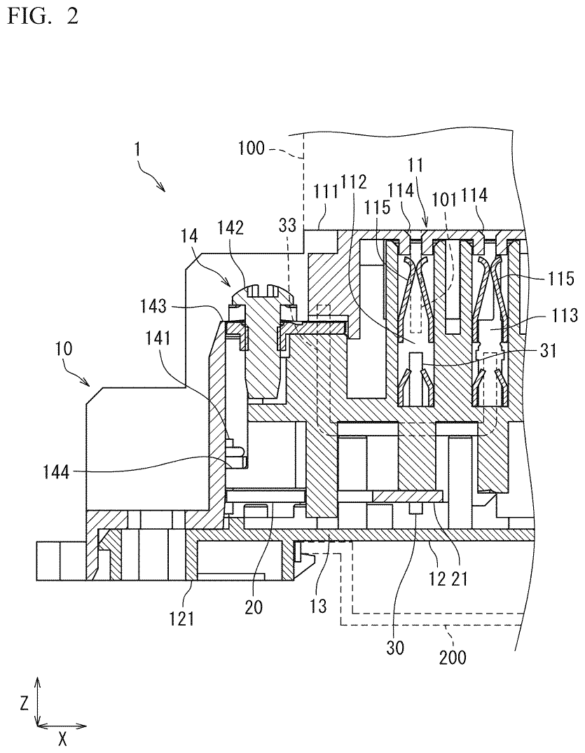

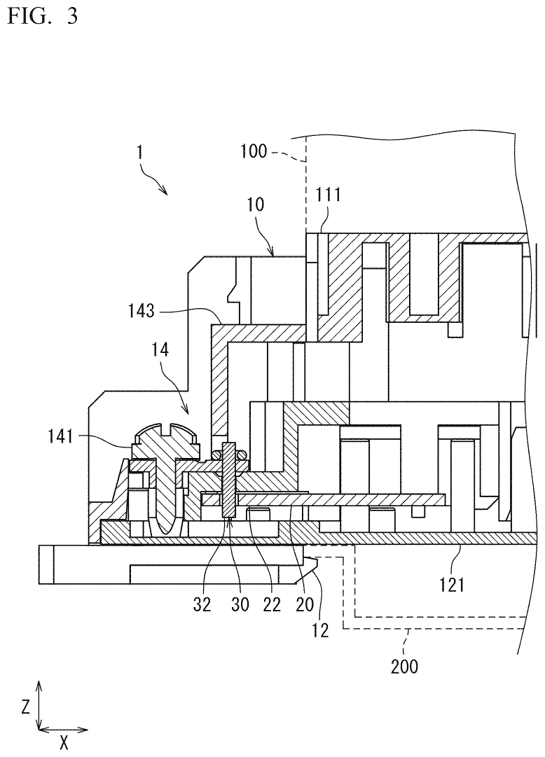

The first attachment part 11 is configured such that an electronic device 100 (shown in FIG. 2 and FIG. 3), such as a relay is attachable in a state in which the electronic device 100 is electrically connected. In the present embodiment, the first attachment part 11 includes an attachment surface 111 to which the electronic device 100 is attachable, and a plurality of terminal housing parts that are positioned inside the housing 10 and are configured to house a terminal 101 of the electronic device 100, respectively.

As shown in FIG. 2, the first attachment part 11 includes two first terminal housing parts 112 electrically connectable to the substrate 20, and six second terminal housing parts 113 electrically unconnectable to the substrate 20. The first terminal housing parts 112 and the second terminal housing parts 113 are positioned to form a “2×4” lattice in which the first terminal housing parts 112 and the second terminal housing parts 113 are arranged to be spaced apart in a second direction (for example, X direction) intersecting the first direction Z and in a third direction (for example, Y direction) intersecting the first direction Z and the second direction X. As shown in FIG. 2, each of the two first terminal housing parts 112 is positioned at an end of a row of the four terminal housing parts.

The first terminal housing parts 112 and the second terminal housing parts 113 are connected to an outside of the housing 10 through openings 114. Holding members 115 configured to hold the housed terminal 101 of the electronic device 100 are housed inside the first terminal housing parts 112 and the second terminal housing parts 113. One end of the solid wire 30 is connected to the holding member 115, and the held terminal 101 of the electronic device 100 and the solid wire 30 are electrically connected.

The second attachment part 12 is configured to attach the socket 1 to a support, such as a control panel. In the present embodiment, the second attachment part 12 is provided on a bottom surface 121 of the housing 10, the bottom surface 121 extending substantially parallel to the attachment surface 111 of the first attachment part 11. The second attachment part 12 is configured to attach the socket 1 to a DIN rail 200, which is one example of the support.

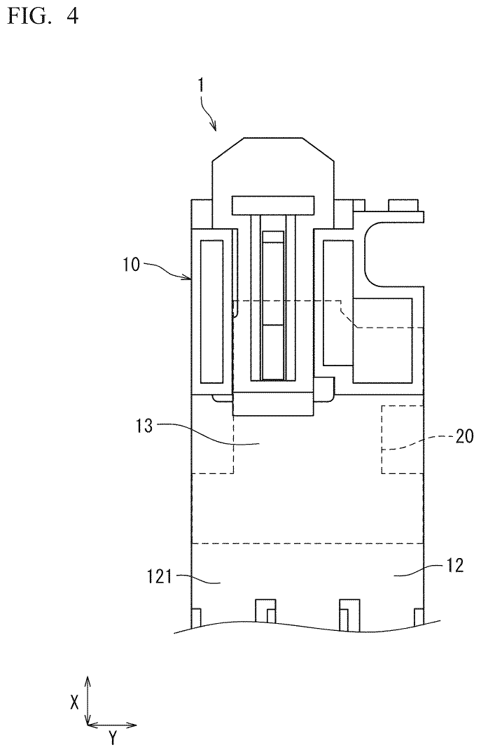

The insulating part 13 is made of an insulating material, such as a resin. The insulating part 13 is positioned between the second attachment part 12 and the substrate 20, and is configured to insulate the substrate 20 from the second attachment part 12. As shown in FIG. 4, the insulating part 13 is not provided with a through-hole, so that a sufficient insulation distance is secured between the DIN rail 200 attached to the second attachment part 12, and the substrate 20.

The terminal connection part 14 is positioned to be spaced apart from the first attachment part 11 in the second direction (for example, X direction) intersecting the first direction Z. In the present embodiment, as shown in FIG. 1, the terminal connection part 14 is positioned at one end of both end parts of the housing 10 in the second direction X, and is adjacent to the first attachment part 11. The terminal connection parts 14 includes two first terminal connection parts 141 electrically connectable to the substrate 20, and two second terminal connection parts 142 electrically unconnectable to the substrate 20.

The first terminal connection parts 141 and the second terminal connection parts 142 are configured to connect an electric wire with a screw as an example. The first terminal connection parts 141 and the second terminal connection parts 142 are positioned to be spaced apart in the second direction X. The first terminal connection parts 141 are positioned in the second direction X farther from the first attachment part 11 than the second terminal connection parts 142. Differences in level in the first direction Z are provided between the first terminal connection parts 141 and the second terminal connection parts 142. As shown in FIG. 2, in the first direction Z, assuming that a step close to the first attachment part 11 is an upper step 143, and a step close to the second attachment part 12 is a lower step 144, the first terminal connection part 141 is positioned in the lower step 144, and the second terminal connection part 142 is positioned in the upper step 143.

The substrate 20 is positioned at an end part close to the second attachment part 12, of the both end parts in the first direction Z inside the housing 10. In the present embodiment, the substrate 20 has a substantially rectangular plate shape, and is positioned along the bottom surface 121 of the housing 10. A circuit configured to reduce power consumption of the electronic device 100 is mounted on the substrate 20. The circuit includes, for example, a PWM control circuit and a KickStart control circuit. The bottom surface 121 of the housing 10 on which the second attachment part 12 is provided, is typically larger than the other surfaces of the housing 10. Thus, when the substrate 20 is positioned at an end part close to the second attachment part 12 inside the housing 10 (for example, along the bottom surface 121), the substrate 20 can be positioned inside the housing 10 without increasing a size of the housing 10. As a result, the socket 1 can be formed with the same outer size as existing products, for example.

As shown in FIG. 2 and FIG. 3, the solid wire 30 is positioned inside the housing 10. In the present embodiment, the solid wire 30 includes a first solid wire 31, a second solid wire 32, and a third solid wire 33.

As shown in FIG. 2, the first solid wire 31 linearly extends from the first attachment part 11 to one end part of the both end parts of the substrate 20 in the second direction X (hereinafter referred to as a first end part 21). As shown in FIG. 3, the second solid wire 32 linearly extends from the terminal connection part 14 to the other end part of the both end parts of the substrate 20 in the second direction X (hereinafter referred to as a second end part 22). The first solid wire 31 and the second solid wire 32 are electrically connected to the circuit mounted on the substrate 20.

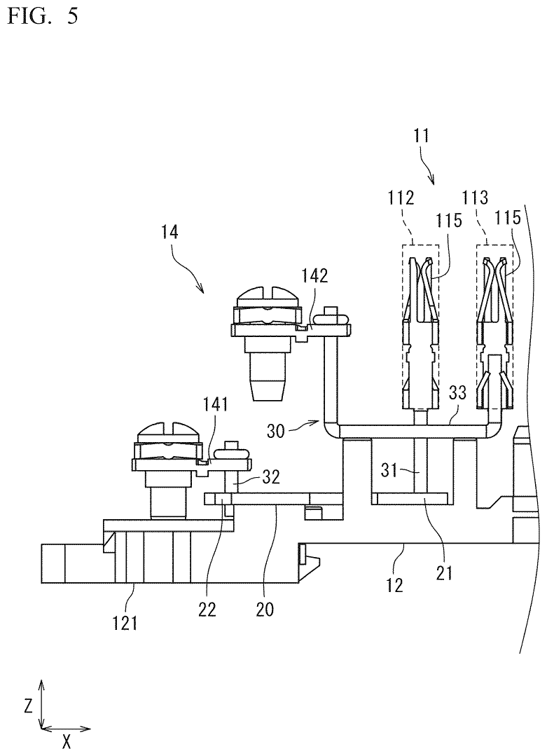

In the present embodiment, one end of the first solid wire 31 is connected to the holding member 115 of the first terminal housing part 112, and the other end of the first solid wire 31 is connected to the first end part 21 of the substrate 20. One end of the second solid wire 32 is connected to the first terminal connection part 141, and the other end of the second solid wire 32 is connected to the second end part 22 of the substrate 20. That is, as shown in FIG. 5, the first solid wire 31, the substrate 20, and the second solid wire 32 are connected to have a substantially C shape as a whole when viewed in the third direction Y.

As shown in FIG. 5, the third solid wire 33 has a substantially C shape as a whole when viewed in the third direction Y, as one example. One end of the third solid wire 33 is connected to the holding member 115 of the second terminal housing part 113, and the other end of the third solid wire 33 is connected to the second terminal connection part 142.

The socket 1 can exhibit the following effects.

The socket 1 includes the housing 10 and the substrate 20. The housing 10 includes the first attachment part 11 and the second attachment part 12 that are positioned to be spaced apart in the first direction Z. The first attachment part 11 is configured such that the electronic device 100 is attachable in a state in which the electronic device 100 is electrically connected. The second attachment part 12 is configured to be attachable to the DIN rail 200. The substrate 20 is positioned at the end part close to the second attachment part 12, of the both end parts in the first direction Z inside the housing 10, and the circuit configured to reduce the power consumption of the electronic device 100 is mounted on the substrate 20. The housing 10 includes the insulating part 13 that is positioned between the second attachment part 12 and the substrate 20, and insulates the substrate 20 from the second attachment part 12. With such a configuration, it is possible to achieve the socket 1 capable of reducing power consumption of the electronic device 100 to be connected.

The electronic device 100, such as a relay, is a consumable article, and requires regular replacement. A socket, on the other hand, can be used for a long period of time as long as a standard or a configuration, such as a layout, is not changed. Thus, when not only the electronic device 100 but also the socket 1 includes a low power consumption circuit, it is possible to inhibit occurrence of work, such as rewiring, to the low power consumption circuit.

The socket 1 includes the first solid wire 31 and the second solid wire 32 that are positioned inside the housing 10, have a linear shape, and are electrically connected to the circuit. With such a configuration, it is possible to more reliably achieve the socket 1 capable of reducing power consumption of the electronic device 100 to be connected.

The housing 10 includes the terminal connection parts 14 positioned to be spaced apart from the first attachment part 11 in the second direction X. The first solid wire 31 extends linearly from the first attachment part 11 to the first end part 21 of the substrate 20, and is electrically connected to the circuit. The second solid wire 32 extends linearly from the terminal connection part 14 to the second end part 22 of the substrate 20, and is electrically connected to the circuit. With such a configuration, it is possible to more reliably achieve the socket 1 capable of reducing power consumption of the electronic device 100 to be connected.

The socket 1 may be configured as follows.

The socket 1 is configured such that the substrate 20 is positioned at the end part on the second attachment part 12 side inside the housing 10, and the insulating part 13 is positioned between the second attachment part 12 and the substrate 20. For example, the solid wire 30 is not limited to the case of including the first solid wire 31, the second solid wire 32, and the third solid wire 33. The solid wire 30 may include only the third solid wire 33 or may include a solid wire other than the first solid wire 31, the second solid wire 32, and the third solid wire 33.

The first attachment part 11 may adopt any configuration configured to attach the electronic device 100. For example, the number of a terminal housing part may be changed according to the design of the socket 1, and the like.

The second attachment part 12 may adopt any configuration configured to attach the socket 1 to the support. That is, the configuration of the second attachment part 12 may be changed according to a configuration of the support.

The insulating part 13 may adopt any configuration configured to insulate the substrate 20 from the second attachment part 12.

The terminal connection part 14 is not limited to the case of being configured to connect an electric wire with a screw. That is, the socket 1 is not limited to a socket of screw connection type, and may be, for example, a socket of push-in connection type.

Various embodiments of the present disclosure have been described above in detail with reference to the drawings, and finally, various aspects of the present disclosure will be described. As one example, reference signs are added in the following description.

A socket 1 according to a first aspect of the present disclosure includes:
a housing 10 including a first attachment part 11 and a second attachment part 12 that are positioned to be spaced apart in a first direction, the first attachment part 11 being configured such that an electronic device is attachable in a state in which the electronic device is electrically connected, and the second attachment part 12 being configured to be attachable to a support; and
a substrate 20 on which a circuit configured to reduce power consumption of the electronic device is mounted, the substrate 20 being positioned at an end part close to the second attachment part 12, of both end parts in the first direction inside the housing 10, wherein
the housing 10 includes an insulating part 13 that is positioned between the second attachment part 12 and the substrate 20, and insulates the substrate 20 from the second attachment part 12.

The socket 1 according to a second aspect of the present disclosure includes, in the socket 1 according to the first aspect,
a first solid wire 31 and a second solid wire 32 that have a linear shape, and are positioned inside the housing 10 and electrically connected to the circuit.

In the socket 1 according to the first aspect of the present disclosure,
the housing 10 includes, in the socket 1 according to the second aspect, a terminal connection part 14 positioned to be spaced apart from the first attachment part 11 in a second direction intersecting the first direction,
the first solid wire 31 extends linearly from the first attachment part 11 to one end part of both end parts of the substrate 20 in the second direction, and is electrically connected to the circuit, and
the second solid wire 32 extends linearly from the terminal connection part 14 to the other end part of the both end parts of the substrate 20 in the second direction, and is electrically connected to the circuit.

Any embodiment or modification of the various embodiments or modifications is appropriately combined, thereby becoming possible to achieve the respective effects. In addition, combinations of embodiments, combinations of examples, or combinations of embodiments and examples are possible, and combinations of features in different embodiments or examples are also possible.

While the present disclosure has been fully described in connection with preferred embodiments with reference to the accompanying drawings, various modifications and alterations are apparent to those skilled in the art. It is to be understood that such modifications and alterations are included within the scope of the present disclosure as set forth in the appended claims without departing from the scope thereof.

### INDUSTRIAL APPLICABILITY

The present disclosure is applicable to, for example, a relay socket.

### REFERENCE SIGNS LIST

1 Socket
10 Housing
11 First attachment part
101 Terminal
111 Attachment surface
112 First terminal housing part
113 Second terminal housing part
114 Opening
115 Holding member
12 Second attachment part
13 Insulating part
14 Terminal connection part
141 First terminal connection part
142 Second terminal connection part
20 Substrate
21 First end part
22 Second end part
30 Solid wire
31 First solid wire
32 Second solid wire
33 Third solid wire
100 Electronic device
200 DIN rail

1. A socket, comprising:
a housing including a first attachment part and a second attachment part that are positioned to be spaced apart in a first direction, the first attachment part being configured such that an electronic device is attachable in a state in which the electronic device is electrically connected, and the second attachment part being configured to be attachable to a support; and
a substrate on which a circuit configured to reduce power consumption of the electronic device is mounted, the substrate being positioned at an end part close to the second attachment part, of both end parts in the first direction inside the housing, wherein
the housing includes an insulating part that is positioned between the second attachment part and the substrate, and insulates the substrate from the second attachment part.

2. The socket according to claim 1, comprising,
a first solid wire and a second solid wire that have a linear shape, and are positioned inside the housing and electrically connected to the circuit.

3. The socket according to claim 2, wherein
the housing includes a terminal connection part positioned to be spaced apart from the first attachment part in a second direction intersecting the first direction,
the first solid wire extends linearly from the first attachment part to one end part of both end parts of the substrate in the second direction, and is electrically connected to the circuit, and
the second solid wire extends linearly from the terminal connection part to the other end part of the both end parts of the substrate in the second direction, and is electrically connected to the circuit.
